(19) United States
(12) Patent Application Publication
(10) Pub. No.: US 2009/0150978 A1
(43) Pub. Date: Jun. 11, 2009

(54) ACCESS CONTROL OF CONTENT SYNDICATION

(76) Inventors: Tao Wu, Shanghai (CN); Bo Xie, Shanghai (CN); Jane Xu, San Jose, CA (US); Hai Jun Zhong, Shanghai (CN)

Correspondence Address: HOFFMAN WARNICK LLC, 75 STATE ST, 14TH FLOOR, ALBANY, NY, 12207, US

(21) Appl. No.: 12/260,528

(22) Filed: Oct. 29, 2008

(30) Foreign Application Priority Data
Dec. 6, 2007 (CN) 200710194166.1

(51) Int. Cl. G06F 21/00; H04L 9/08; H04L 9/14

(52) U.S. Cl. 726/4; 380/282; 380/44

(57) ABSTRACT

A content syndication access control solution is provided. An illustrative content syndication access control system comprises: a syndication subscriber for acquiring a authorized content syndication feed; content syndication providing means for authorizing the syndication subscriber according to a public key and submitting content to a syndication server; and the syndication server for performing an authorization on content items according to the public key and a symmetric key and encrypting the authorized content items and the symmetric key, and generating the content syndication feed according to the encrypted content items and the symmetric key. By means of the system, the granularity of access control can become finer, and the consolidated content feed maintains all access control information, so existing access control remains valid.

### REFERENCE TO PRIOR APPLICATION

The current application claims the benefit of co-pending Chinese Patent Application No. 200710194166.1, titled “Method and system for access control of content syndication”, which was filed on 6 Dec. 2007, and which is hereby incorporated by reference.

### TECHNICAL FIELD

The present invention generally relates to a method and a system for access control of content syndication in a computer network system. In particular, the present invention relates to a method and a system for access control of content syndication in a computer network system comprising at least one syndication server, at least one syndication subscriber and at least one content syndication provider.

### BACKGROUND ART

Content syndication enables website content to be used by other services. Content syndication, or referred to as a feed, is provided with a title line, a link and an article feed, and it describes a series of information, in which a symbol, a website link, an input area and a news item can be included. Another internet website can automatically integrate that information into its own webpage, or use the feed to provide a current news title line for the website.

Before content syndication emerged, a user needed to visit every website to search for the latest information. At present, however, news is delivered to a browser, a desktop and an aggregator directly through the feed. Dynamic network interaction became media to be easily utilized due to the emergence of content syndication. Currently, well known content syndication providers include Google blogger, Microsoft MSN Space, etc., well known aggregator providers include Google Reader, FeedDemon, etc., and protocols include RSS (Really Simple Syndication), etc.

In recent years, a Blog is becoming the hottest topic of the internet, and RSS is the most fundamental method to describe a Blog theme and update information. The technology of RSS, therefore, has been gaining attention and development, and has been widely used in various Blog tools and supported by many professional news websites. Subscribers are encouraged to increase RSS output thereby enabling many news aggregation tools to find you easily and obtain Blog content updated by you. That is, using the RSS function can enable people on the Internet to easily find that you have updated your website and keep track of all Blogs that have been read by you.

By means of supporting RSS, a web browser can subscribe to a Blog, news, and the like, rather than searching for a desired Blog, news, and the like one website by one website, and one webpage by one webpage. When content desired by a subscriber is subscribed to in a RSS browser, the content can be automatically made available in the browser at the subscriber, and the subscriber does not need to continuously refresh the webpage in order to acquire news timely since the subscriber is automatically informed by the RSS reader upon updating.

After a server issues a RSS document (RSS feed), information contained in the RSS feed can be directly called by other websites, and since the information takes standard XML formats, it can also be used in other terminals and services such as PDA, cellular phone, email lists, and the like. Additionally, website allies (for example, a series of websites specialized in discussing topics related to travel) can display the latest information of another allied website by mutually calling a RSS feed of each other, this is called RSS syndication. Such syndication can enable website content to be timely updated, and the more frequently a RSS feed is called, the more well known the website becomes. Moreover, RSS aggregation searches various RSS feeds from the Internet using a software tool and provides it to readers in one interface.

With more and more websites supporting RSS, RSS has become the most successful XML application so far. RSS builds up a technical platform for fast information delivery, and turns every person into a potential information provider. It is believed that there will be more RSS based professional portals, aggregation websites, and more precise search engines.

Although the RSS value chain has made significant progress for sharing and exchanging news and other items, it has weak links in many fields. For instance, RSS is not good at presenting, searching, signaling, and network routing. Currently, RSS is not able to provide enterprise level features such security, privacy, data integrity, and QoS (quality of service).

Access control is an indispensable part of content syndication in most cases. For example, there may be some private information in a Blog written by a user, which is expected to be accessed only by an authorized person but prohibited for others. In this case, a Blog feed will need to provide an access control mechanism.

The existing method for access control of content syndication is to use an access control mechanism of the Hypertext Transfer Protocol (HTTP) (http://www.w3.org/Protocols/rfc2616/rfc2616-sec11.html#sec11). Since a feed is mainly transmitted via HTTP, the access control mechanism of HTTP can manage access control for the entire feed, for example,

http://username:password@example.com/feed.xml and

http://username:passwordDigest@example.com/feed.xml.

Since the access control mechanism of HTTP transmits in plain text, the current approach uses a security socket layer (SSL) to enhance the security, for example, https://username:password@example.com/feed.xml.

There are two problems for the above mentioned approach. The first problem is that the granularity of access control is too rough. The user usually wants only some content of a feed to be accessible by an authorized person, but other content can be accessed by any person. For example, there may be 100 articles in a writer's Blog, three of which should be set to be accessible by one specific authorized person, another four articles should be set to be accessible by another specific authorized person, and the remaining 93 articles should be set to be accessible by any person. The current HTTP based access control mechanism cannot meet such a requirement, since it can only manage access control for the entire feed: either all content of the feed is accessible, or any content of the feed is not accessible.

Another problem is that original access control is invalid after a feed is aggregated. A feed is usually consolidated by another program, for example,

http://pipes.yahoo.com.

After a feed is aggregated, the current HTTP based access control mechanism loses the access control to the aggregated feed. For example, when ten feeds are consolidated by another program as a new feed to be placed on another server, all access control to the original ten feeds is invalid for the new feed.

### SUMMARY OF THE INVENTION

Considering the above problems, embodiments of the present invention provide a content syndication access control system and a content syndication access control method, which enable a subscriber to manage all content or any part of the content of a feed (for example, a Blog feed).

For realizing the above purpose of the present invention, according to an aspect of the present invention, a content syndication access control system is provided comprising: a syndication subscriber for acquiring an authorized content syndication feed; a content syndication provider for authorizing the content syndication subscriber according to a public key and delivering content to a content syndication server; and the content syndication server for performing authorization as to content items according to the public key and a symmetric key and encrypting the authorized content items and the symmetric key, and generating the content syndication feed according to the encrypted content items and the symmetric key.

According to another aspect of the present invention, a content syndication access control method is provided comprising: verifying whether a subscriber public key is valid; performing authorization as to content items accessed by the subscriber according to result of the verifying, and submitting the authorized content items; and generating a symmetric key, using the symmetric key to encrypt the authorized and submitted content items, using the public key of the authorized subscriber to encrypt the symmetric key, and using the encrypted symmetric key together with the encrypted content items to generate a content syndication feed.

By means of the above mentioned solution, content items can be controlled such that granularity of access control becomes finer and even access control at an article level is possible. In addition, all access control information of the present invention (for example, a public key identification, an encrypted symmetric key, and the like) are internally contained in content items of the feed, but the HTTP based access control depends on an external server. Content consolidated by the present invention still contains all access control information, so existing access control remains valid.

### DESCRIPTION OF FIGURES

FIG. 1 is a structural schematic view for illustrating a distributed data processing system in which the present invention can be applied;

FIG. 2 is a detailed structural schematic view for illustrating a distributed data processing system in which the present invention can be applied;

FIG. 3 is a system level flowchart illustrating a content syndication platform comprising access control according to an embodiment of the present invention;

FIG. 4 is a flowchart of a key exchanging process of a computer network system according to a preferred embodiment of the present invention;

FIG. 5 is a flowchart of a key verification process of the computer network system according to a preferred embodiment of the present invention;

FIG. 6 is a flowchart of a content submission and authorization process of the computer network system according to a preferred embodiment of the present invention;

FIG. 7 is a flowchart of a feed generating process of the computer network system according to a preferred embodiment of the present invention;

FIG. 8 is a flowchart of a content syndication retrieving process of the computer network system according to a preferred embodiment of the present invention;

FIG. 9 is an example of an original feed according to a preferred embodiment of the present invention;

FIG. 10 is a diagram of content C according to a preferred embodiment of the present invention; and

FIG. 11 is an example of a syndication feed of access control information according to a preferred embodiment of the present invention, which mixes public content and restricted content in a syndication feed.

### DETAILED DESCRIPTION

Preferred embodiments of the present invention are now described with reference to the figures. The present invention, however, can be implemented in various forms, and is not limited to the preferred embodiments described herein. In particular, the preferred embodiments are provided to disclose general principles of the present invention comprehensively, and describe the scope of the present invention to a person having ordinary skill in the art. In the figures, the same reference sign is used to indicate elements with the same or similar functions in order to make them easier to be identified by readers.

Moreover, it should be understood that when a component is described as being “connected” or “coupled” with another component, it can be directly connected or coupled with another component or there could be intervening component(s) there between, and in opposite, when a component is described as being “directly connected” or “directly coupled” with another component, there is no intervening component there between. As used herein, the term “and/or” comprises any and all combinations of one or a plurality of technical terms listed in connection, and can be expressed by “/”.

The technical terms used herein are only for the description purpose and are not intended to limit the present invention. As used in the present description, non-plurality forms “a”, “an” and “the” also include the plurality form unless being set forth explicitly in context. It should also be understood that terms “comprising” or “including” are used herein to describe existence of a feature, a step, an operation, a component, and the like, but do not exclude the existence of an additional one or more other features, steps, operations, components, and the like.

Unless defined otherwise, all terms used herein (including technical terms and scientific terms) have common meanings as understood by a person having ordinary skill in the art. It should also be understood that terms defined in common dictionaries should be interpreted as having meanings consistent with those to be reasonable under the circumstance of the related art and/or the present invention, and not to be interpreted on an ideal or superfluous formal basis unless being set forth explicitly therein.

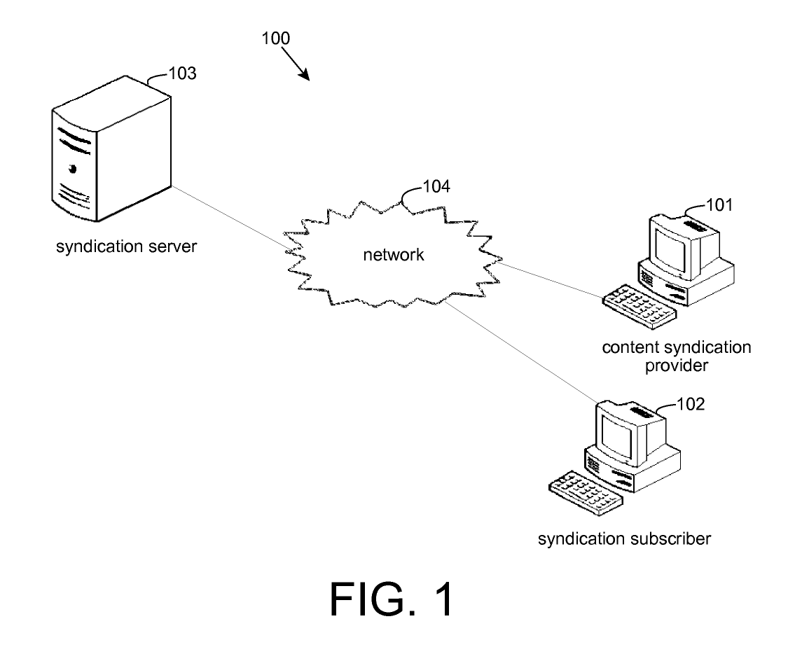

Reference is now made to FIG. 1, which is a structural schematic view of a distributed data processing system in which the present invention can be applied. The present invention can be applied in a distributed data processing system 100 comprising a network 104 and various computing devices and computers connected to each other via network 104, wherein the network 104 is media for providing a communication link among the various computing devices and computers. The network 104 can comprise fixed connections such as coaxial cables, optical fibers, telephone implementations, or the like, as well as wireless network connections implemented by wireless devices such as wireless routers.

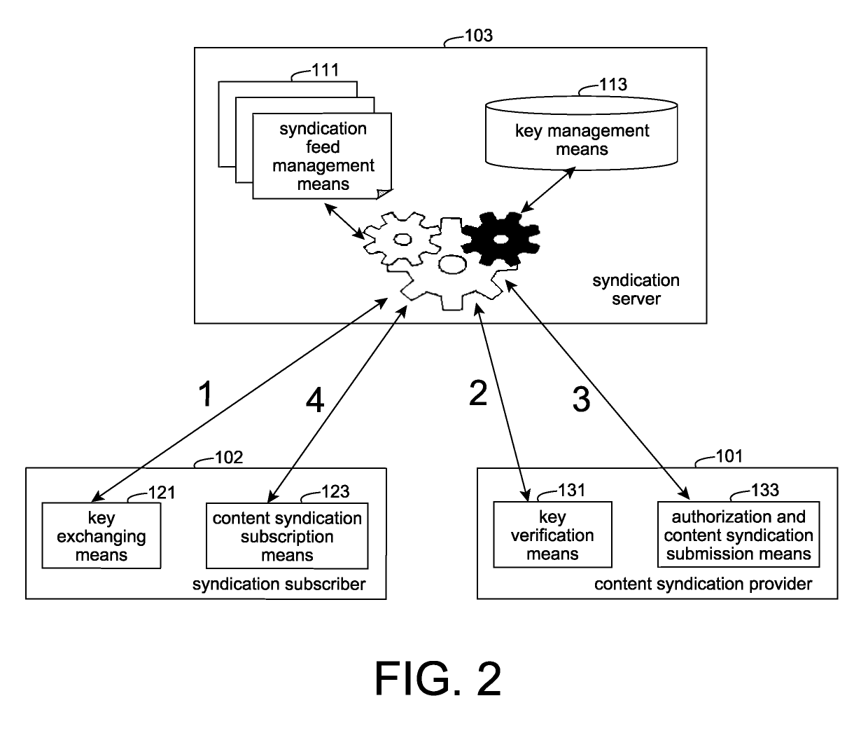

In an embodiment, a syndication server 103 is connected to network 104. In addition, a content syndication provider 101 and a syndication subscriber 102 are connected to network 104. As an example, content syndication provider 101 and syndication subscriber 102 can be a personal computer or a network computer. As to the present invention, the network computer can be any network connected computer capable of receiving programs or other data from other computers connected to the network. In an embodiment, a syndication management service program resides at the syndication server 103, and can provide a syndication management service to the content syndication provider 101 and the syndication subscriber 102 via the network 104. In this embodiment, therefore, the server 103 is referred to as a syndication server, and the subscriber 102 is a syndication consumer of the syndication server 103. The distributed data processing system 100 can also comprise other servers, subscribers and other devices which are not shown. In particular, any of the content syndication provider 101, the syndication subscriber 102, or the syndication server 103 can be more than one. For simplification, only the case with one content syndication provider 101, one syndication subscriber 102 and one syndication server 103 is shown in FIG. 1 of the embodiment according to the present invention. Referring to FIG. 2, FIG. 2 shows the detailed structure of a content syndication access control system using a RSS reader, according to the present invention.

The content syndication access control system comprises the syndication server 103, the syndication subscriber 102 and the content syndication provider 101. The syndication server 103 manages syndication feeds and keys, and comprises syndication feed management means 111 and key management means 113. The syndication subscriber 102 manages subscriber information, and comprises key exchanging means 121 and content syndication subscription means 123. The content syndication provider 101 manages content syndication providing actions, and comprises key verification means 131 and authorization and content syndication submission means 133.

The syndication feed of the present invention comprises, but is not limited to: a title, a group of public key identifications, an encrypted symmetric key, and encrypted syndication feed content. The syndication feed content of the present invention will be further discussed in connection with FIG. 10.

Referring to FIG. 2, the respective parts of the syndication server 103, the syndication subscriber 102 and the content syndication provider 101 in the content syndication access control system according to the present invention work together to realize the following functions: a key exchanging and verification function, a content syndication submission function, and a content data submission issuance function. In connection with the illustration of FIG. 2, the key exchanging and verification function, the content syndication submission function and content feed issuance function will be described in detail according to a preferred embodiment of the present invention.

### (1) Key Exchanging and Verification Function

For the exchanging and verification function, the syndication subscriber 102 and the key exchanging means 121 generate a public key and a private key and provide the public key to the syndication server 103, the public key comprises but is not limited to: public key server information, a password identification, a name, an email address, and the like. The key management means 113 of the syndication server 103 makes a preliminary judgment about its authenticity and stores the related information in local memory (for example, a local cache). In particular, the key verification means 131 of the content syndication provider 101 obtains the public key information submitted by the key exchanging means 121 of the syndication subscriber 102 via the key management means 113 of the syndication server 103. As an alternative, according to another embodiment of the present invention, the syndication subscriber 102 is used to generate a public key, and the syndication server 103 can be provided with a function for generating a valid public key for the syndication subscriber 102. In such a circumstance, the syndication subscriber 102 does not need to submit the valid public key through a secure network protocol, and the syndication server 103 generates the public key for the syndication subscriber 102.

### (2) Content Syndication Submission Function

The content syndication provider 101 acquires the public key of the syndication subscriber 102, which was determined to be authorized via the key management means 113 of the syndication server 103, and which comprises but is not limited to: public key server information, a password identification, a name, an email address, and the like. Subsequently, the content syndication provider 101 performs authorization of the syndication subscriber 102 through the key management means 113 of the syndication server 103. Authorization and content syndication submission means 133 of the content syndication provider 101 submits the content authorized for the syndication subscriber 102 to the syndication server 103.

The syndication server 103, according to the information provided to the syndication server 103 by the syndication subscriber 102 under an authorization of the content syndication provider 101, performs the authorization as to a part or all of the restricted content items, so as to allow the authorized syndication subscriber 102 access thereto. The syndication feed management means 111 of the syndication server 103 generates a symmetric key, and uses the symmetric key to encrypt the authorized restricted content items. The syndication server 103 uses the public key submitted by the authorized syndication subscriber 102 to encrypt the symmetric key which is then joined by the encrypted content items to generate the content syndication feed.

### (3) Content Syndication Feed Issuance Function

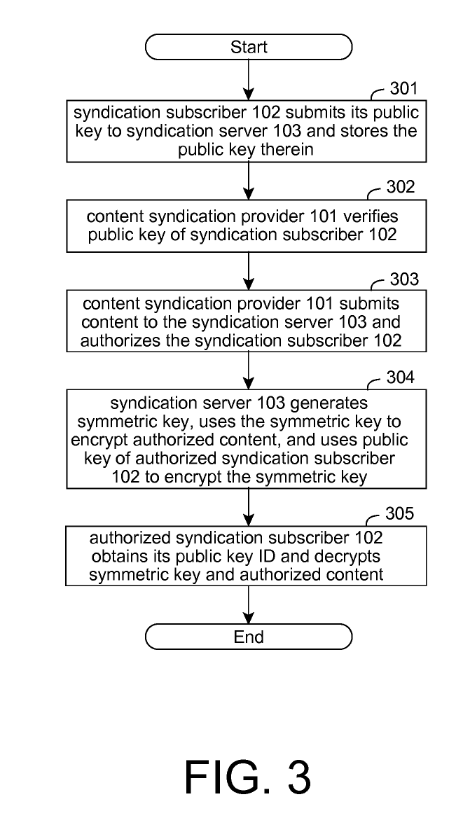

The content syndication subscription means 123 of the syndication subscriber 102 acquires a syndication feed from the syndication feed management means 111 of the syndication server 103, resolves the syndication feed according to the feed content, and acquires the authorized portion of the syndication feed content. A content syndication platform according to a preferred embodiment of the present invention will be described referring to FIG. 3 which is a system level flowchart illustrating a content syndication platform of the access control in the computer network system shown in FIG. 1 and FIG. 2, according to a preferred embodiment of the present invention. As shown in FIG. 3, in the key exchanging step 301, the syndication subscriber 102 generates a public key and a private key and uses the secure network protocol to submit its public key to the syndication server 103. The syndication server 103 stores the public key so that it can be verified by the content syndication provider 101. The syndication subscriber 102 submits its public key to the syndication server 103 for processing, e.g., key exchanging processing, which will be discussed later in detail.

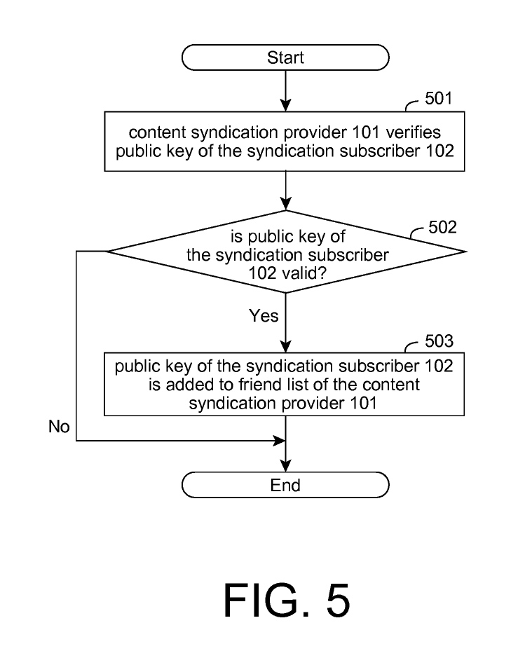

In the key verification step 302, the content syndication provider 101 verifies the public key of the syndication subscriber 102, which is stored at the syndication server 103. The public key verification processing of the content syndication provider 101 will be described later in detail in connection with FIG. 5.

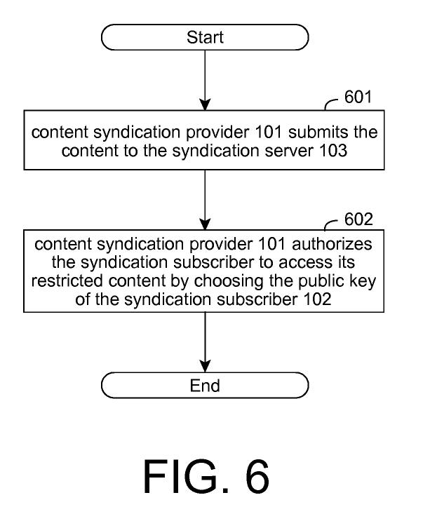

Next, in content submission and authorization step 303, the content syndication provider 101 submits the content to the syndication server 103, and performs the authorization as to the syndication subscriber 102 by choosing a public key of the syndication subscriber 102 for the authorized content. The content submission and authorization processing will be discussed later in detail by referring to FIG. 6.

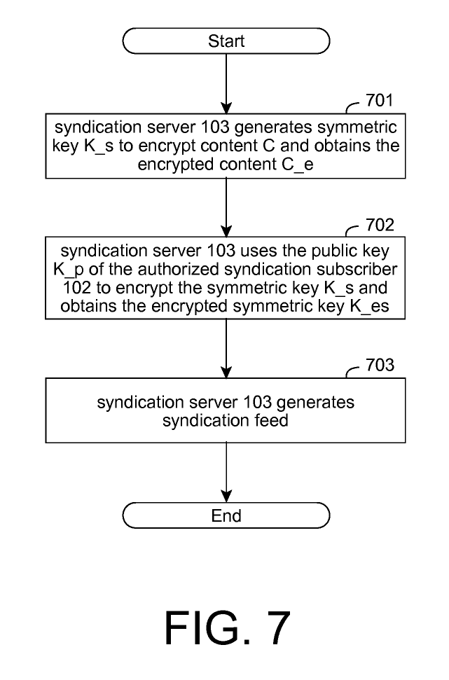

Next, in the content syndication feed generating step 304, the syndication server 103 generates a symmetric key. The syndication server 103 uses the symmetric key to encrypt the authorized content. The syndication server 103 uses the public key of the authorized syndication subscriber 102 to encrypt the symmetric key. Content not requiring authorization is included in the feed as well, without any encryption. The syndication server 103 uses the public key provided by the authorized syndication subscriber 102 to encrypt the symmetric key which is then joined by the encrypted content to generate the content syndication feed. The processing performed by syndication server 103 in generating the symmetric key will be discussed later in detail by referring to FIG. 7.

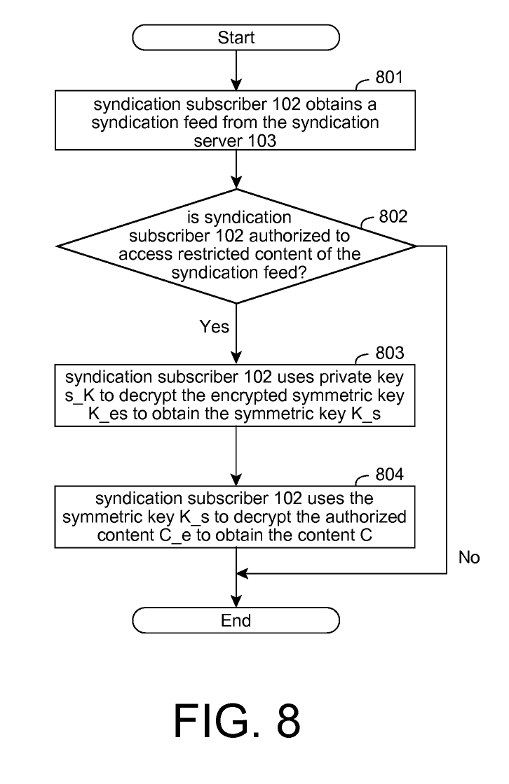

Next, in the content syndication retrieving step 305, the authorized syndication subscriber 102 obtains its public key ID in the syndication feed from the syndication server 103, and uses its private key to decrypt the symmetric key, and then decrypts the authorized content. The content syndication retrieving processing will be discussed later in detail by referring to FIG. 8.

The present invention can resolve two problems that cannot be dealt with by the current HTTP based the access control mechanism. (1) The granularity of the access control of the present invention is finer, which is down to the article level. For example, of 100 articles written by a Blog author, three articles can be encrypted so that only some authorized users can use their private key to decrypt, other articles can be encrypted so that only other authorized users can use their private key to decrypt, and the remaining 93 articles are not encrypted so as to be accessed by any person. (2) All access control information of the present invention (for example, a public key identification, an encrypted symmetric key, and the like) is internally contained in articles of a feed, but the HTTP based access control depends on the external server. The feed consolidated by the present invention still contains all access control information, so the existing access control information is still valid.

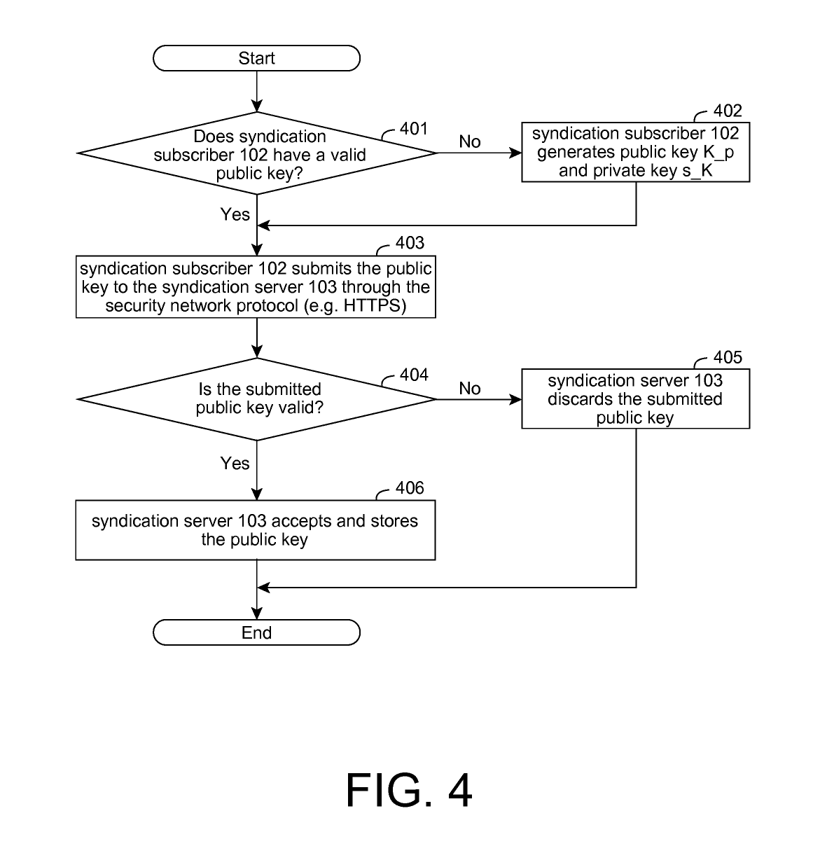

Now, the flowchart of FIG. 3 will be described in detail by referring to FIGS. 4-6. At first, the key exchanging step 301 will be described by referring to FIG. 4, wherein the syndication subscriber 102 submits its public key to the syndication server 103. FIG. 4 is the flowchart of the key exchanging processing shown in FIG. 3. In FIG. 4, in step 401, the syndication subscriber 102 checks whether it has a valid public key. If in step 401 the syndication subscriber 102 can not find a valid public key, then in step 402 public key K_p and private key s_K are generated using any of many methods to generate a valid public key and a private key. For example, openSSL can be used to generate a valid public key K_p and a valid private key s_K, however, the present invention is not limited to use of this tool, and can use another method instead.

Next, in step 403, the syndication subscriber 102 submits the public key K_p found in step 401 or generated in step 402 to the syndication server 103 through the secure network protocol. The secure network protocol used here can be HTTPS protocol, for example, but the present invention is not limited to this, and the other secure protocols can be used.

In another embodiment, the syndication subscriber 102 is used to generate a public key in step 402 in the case that no valid public key is found, the syndication server 103 can have a function to generate a valid public key for the syndication subscriber 102, and in step 403, the syndication server 103 generates a public key rather than a valid public key that is submitted through a secure network protocol.

Next, in step 404, the syndication server 103 checks whether the submitted public key is valid. If in step 404 the submitted public key is determined to be valid, then the syndication server 103 accepts the public key and stores it in step 406, then the key exchanging processing concludes. Alternatively, if in step 404 the submitted public key is determined to be invalid, then the syndication server 103 discards the invalid public key in step 405, then the key exchanging processing concludes.

Now, the key verification step 302 shown in FIG. 3 is described by referring to FIG. 5, which is a flowchart of the key verification process shown in FIG. 3. In FIG. 5, in step 501, the content syndication provider 101 verifies the public key of the syndication subscriber 102. Then, in step 502, it is determined whether the public key of the syndication subscriber 102 is valid. If in step 502 it is determined that the public key of the syndication subscriber 102 is valid, then in step 503 the public key of the syndication subscriber 102 is added to a friend list of the content syndication provider 101. When it is determined that the public key of the syndication subscriber 102 is added to a list of partners, the content syndication provider 101 will follow the decision of the syndication subscriber 102.

Next, the content submission and authorization step 303 shown in FIG. 3 is described by referring to FIG. 6, which is a flowchart for illustrating the content submission and authorization shown in FIG. 3. Referring to FIG. 6, in step 601, the content syndication provider 101 submits the content to the syndication server 103. Then, in step 602, the content syndication provider 101 authorizes the syndication subscriber 102 to access its restricted content by choosing the public key of the syndication subscriber 102.

Next, the content syndication feed generation step shown in FIG. 3 is described by referring to FIG. 7, which is a flowchart of the content syndication feed generation step shown in FIG. 3. Referring to FIG. 7, in step 701, the syndication server 103 generates a symmetric key K_s to encrypt content C and obtains the encrypted content C_e. In step 702, the syndication server 103 uses the public key K_p of the authorized syndication subscriber 102 to encrypt the symmetric key K_s and obtains the encrypted symmetric key K_es. In step 703, the syndication server 103 generates the syndication feed, the feed comprises: (1) key identification (id) of the public key K_p of the authorized syndication subscriber 102; (2) the encrypted symmetric key K_es; and (3) the encrypted content C_e.

FIG. 8 is a flowchart of the content syndication retrieving shown in FIG. 3. Referring to FIG. 8, in step 801, the syndication subscriber 102 obtains a syndication feed from the syndication server 103. In step 802, the syndication subscriber 102 checks whether its public key identification is present in the syndication feed, thereby determining whether it is authorized to access the restricted content of the content syndication feed. If in step 802 it is determined that the syndication subscriber 102 is authorized, then in step 803 the syndication subscriber 102 uses its private key s_K to decrypt the symmetric key K_es to obtain the symmetric key K_s, then in step 804, the syndication subscriber 102 uses the symmetric key K_s to decrypt the authorized content C_e to obtain the content C.

FIG. 9 is an example of an original syndication feed. The original syndication feed comprises public content and restricted content. The present invention is mainly directed to access control of the restricted content. There are two articles in FIG. 9, an XML tag corresponding to an article is “item” in a RSS protocol. The first article has a title of “Public item”, and its content will not be changed after being processed by the present invention and can be accessed by any person. The second article has a title of “Restricted item”, and its content will be encrypted after being processed by the present invention and the encrypted feed is shown in FIG. 11.

FIG. 10 shows content C of the present invention. From FIG. 10, it can be seen that the access control of the present invention is down to the article level, an XML tag corresponding to an article is “item” in the RSS protocol, which comprises XML elements such as “title”, “link”, “description”, “pubDate”, “guid”. Please refer to “RSS 2.0 specification” for more details about the RSS protocol (http://cyber.law.harvard.edu/rss/rss.html).

FIG. 11 is an example of a syndication feed with the access control, and the content syndication feed of the present invention mainly comprises but is not limited to items listed in FIG. 11.

Referring to FIG. 11, in the example, (1) key identification of the public key K_p of the authorized syndication subscriber 102 is “publickeyid1”; (2) encrypted content C_e is “EncryptedContent”; and (3) encrypted symmetric key K_es is “EncryptedSymmetricKey1”.

The present invention can take a form of an entirely hardware embodiment, an entirely software embodiment or an embodiment containing both software and hardware elements. In a preferred embodiment, the present invention is implemented in software, which includes but is not limited to firmware, resident software, microcode, etc.

Furthermore, the present invention can take a form of a computer program product accessible from a computer-usable or computer-readable medium providing program code for use by or in connection with a computer or any instruction execution system. For the purpose of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, a magnetic tape, a removable computer diskette, a random access memory (RAM), a read-only memory (ROM), a rigid magnetic disk drive and an optical disk drive. Current examples of optical disks include the compact disk-read only memory (CD-ROM), the compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provided temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of such network adapters.

The description of the present invention has been presented for the purpose of illustration and description but is not intended to exhaust or limit the present invention in the form disclosed. Many modifications and variants will be apparent to those of ordinary skill in the art. The embodiments are chosen and described in order to best explain the principles of the present invention and the practical application, and to enable others of ordinary skill in the art to understand the present invention for various embodiments with various modifications as are suited to the particular use contemplated.

What we claim is:

1. A content syndication access control system comprising:
a syndication server configured to manage a content syndication feed, wherein the syndication server includes:
an element configured to obtain content for the content syndication feed, wherein the content includes a restricted content item that requires authorization to access;
an element configured to obtain an encrypted restricted content item according to the restricted content item and a symmetric key;
an element configured to obtain an encrypted symmetric key according to the symmetric key and a public key for a syndication subscriber; and
an element configured to generate the content syndication feed, wherein the content syndication feed includes the encrypted restricted content item and the encrypted symmetric key associated with the encrypted restricted content item.

2. The system of claim 1, wherein the syndication server further includes an element configured to obtain an identification that the syndication subscriber is authorized to access the restricted content item, wherein the encrypted symmetric key is included in the content syndication feed in response to the identification.

3. The system of claim 1, wherein the content syndication feed further includes an identifier for the public key associated with the encrypted restricted content item.

4. The system of claim 1, wherein the syndication server further includes an element configured to provide the content syndication feed for processing by the syndication subscriber.

5. The system of claim 1, wherein the content further includes an unrestricted content item that does not require authorization to access, and wherein the content syndication feed further includes the unrestricted content item without encryption.

6. The system of claim 1, further comprising a content syndication provider configured to provide the content for the content syndication feed to the syndication server.

7. The system of claim 1, further comprising the syndication subscriber configured to receive the content syndication feed.

8. The system of claim 1, wherein the syndication server further includes an element configured to generate the public key for the syndication subscriber.

9. The system of claim 1, wherein the syndication server further includes an element configured to receive the public key for the syndication subscriber from the syndication subscriber, and determine whether the public key is valid.

10. A method of managing a content syndication feed, the method comprising:
obtaining content for the content syndication feed, wherein the content includes a restricted content item that requires authorization to access;
obtaining an encrypted restricted content item according to the restricted content item and a symmetric key;
obtaining an encrypted symmetric key according to the symmetric key and a public key for a syndication subscriber; and
generating the content syndication feed, wherein the generating includes the encrypted restricted content item and the encrypted symmetric key associated with the encrypted restricted content item in the content syndication feed.

11. The method of claim 10, further comprising obtaining an identification that the syndication subscriber is authorized to access the restricted content item, wherein the generating includes the encrypted symmetric key in the content syndication feed in response to the identification.

12. The method of claim 10, wherein the generating further includes an identifier for the public key associated with the encrypted restricted content item in the content syndication feed.

13. The method of claim 10, further comprising providing the content syndication feed for processing by the syndication subscriber.

14. The method of claim 10, wherein the content for the syndication feed further includes an unrestricted content item that does not require authorization to access, and wherein the generating further includes the unrestricted content item without encryption in the content syndication feed.

15. The method of claim 10, further comprising generating the public key for the syndication subscriber.

16. A computer program comprising program code embodied in at least one computer-readable medium, which when executed, enables a computer to implement a method of managing a content syndication feed, the method comprising:
obtaining content for the content syndication feed, wherein the content includes a restricted content item that requires authorization to access;
obtaining an encrypted restricted content item according to the restricted content item and a symmetric key;
obtaining an encrypted symmetric key according to the symmetric key and a public key for a syndication subscriber; and
generating the content syndication feed, wherein the generating includes the encrypted restricted content item and the encrypted symmetric key associated with the encrypted restricted content item in the content syndication feed.

17. The computer program of claim 16, the method further comprising obtaining an identification that the syndication subscriber is authorized to access the restricted content item, wherein the generating includes the encrypted symmetric key in the content syndication feed in response to the identification.

18. The computer program of claim 16, wherein the generating further includes an identifier for the public key associated with the encrypted restricted content item in the content syndication feed.

19. The computer program of claim 16, the method further comprising providing the content syndication feed for processing by the syndication subscriber.

20. The computer program of claim 16, wherein the content for the syndication feed further includes an unrestricted content item that does not require authorization to access, and wherein the generating further includes the unrestricted content item without encryption in the content syndication feed.
